(19) United States
(12) Patent Application Publication
(10) Pub. No.: US 2024/0052683 A1
(43) Pub. Date: Feb. 15, 2024

(54) Method for Controlling Power Tailgate System

(71) Applicants: Hyundai Motor Company, Seoul (KR); Kia Corporation, Seoul (KR)

(72) Inventors: Duck Young Kim, Hwaseong-si (KR); Jun Hyuk Kim, Yongin-si (KR)

(21) Appl. No.: 18/179,001

(22) Filed: Mar. 6, 2023

(30) Foreign Application Priority Data
Aug. 10, 2022 (KR) 10-2022-0100081

(51) Int. Cl. E05F 15/622; E05B 81/06; E05B 81/20; E05B 81/66

(52) U.S. Cl. CPC E05F 15/622; E05B 81/06; E05B 81/20; E05B 81/66; E05Y 2201/21; E05Y 2201/434; E05Y 2201/702; E05Y 2201/70; E05Y 2201/474; E05Y 2400/40; E05Y 2800/406; E05Y 2900/546

(57) ABSTRACT

An embodiment method for controlling a power tailgate system including a tailgate, a spindle drive, and a latch is provided. The method includes retracting the spindle drive when a closing signal of the tailgate is generated, stopping the spindle drive when a claw of the latch reaches a partially latched position as the tailgate is closed, and retracting the spindle drive while simultaneously performing latch cinching after the spindle drive is stopped, wherein performing the latch cinching comprises moving the claw of the latch from the partially latched position to a fully latched position.

### CROSS-REFERENCE TO RELATED APPLICATIONS

This application claims the benefit of Korean Patent Application No. 10-2022-0100081, filed on Aug. 10, 2022, which application is hereby incorporated herein by reference.

### TECHNICAL FIELD

The present disclosure relates to a method for controlling a power tailgate system.

### BACKGROUND

A vehicle such as a sport utility vehicle (SUV) or a multi-purpose vehicle (MPV) may have a luggage compartment that carries luggage on a rear portion thereof, and such a luggage compartment may be opened and closed by a tailgate. The tailgate may be pivotally mounted through a hinge system provided on an upper end of a rear portion of a vehicle body, and the tailgate may be opened and closed by a pair of spindle drives. The pair of spindle drives may be spaced apart from each other in a widthwise direction of the vehicle. The pair of spindle drives may be disposed between the vehicle body and the tailgate.

The tailgate may have a latch provided on a bottom end thereof, and the vehicle body may have a striker provided on a lower end of the rear portion thereof. The tailgate may be locked or unlocked by the latch and the striker. A weather seal such as a weather strip may be provided between an edge of the tailgate and the vehicle body. When the tailgate is closed, the tailgate may fail to move to a fully closed position due to a weather seal pressure, but may be in a partially closed position. Accordingly, latch cinching may be performed to assist the retraction or compression of the spindle drive against the weather seal pressure when the power tailgate is closed. Here, the latch cinching may be a process of moving (or rotating) a claw of the latch from a partially latched position to a fully latched position by a motor of the latch. That is, the latch cinching may be performed to assist vehicle users in closing a door against weather seal pressure.

The partially latched position refers to a state in which the tailgate is held in the partially closed position as the claw of the latch is partially engaged with the striker. The fully latched position refers to a state in which the tailgate is held in the fully closed position as the claw of the latch is fully engaged with the striker.

During the latch cinching, however, the spindle drive may be in a stopped state, and a brake torque (reaction force) generated by the spindle drive may cause a relatively large bending deformation in a portion of the tailgate connected to the spindle drive. When the tailgate is closed, the deformation of the tailgate may be excessive due to the reaction force acting on the spindle drive. In order to cope with such deformation, the thicknesses of various reinforcements provided to the tailgate may increase or the structures of some reinforcements may change, which may result in the increased manufacturing cost and increased weight of the tailgate.

The above information described in this background section is provided to assist in understanding the background of the inventive concept, and may include any technical concept which is not considered as the prior art that is already known to those skilled in the art.

### SUMMARY

The present disclosure relates to a method for controlling a power tailgate system. Particular embodiments relate to a method for controlling a power tailgate system capable of significantly reducing or preventing deformation of a tailgate during latch cinching.

Embodiments of the present disclosure can solve problems occurring in the prior art while advantages achieved by the prior art are maintained intact.

An embodiment of the present disclosure provides a method for controlling a power tailgate system capable of significantly reducing or preventing deformation of a tailgate during latch cinching.

According to an embodiment of the present disclosure, a method for controlling a power tailgate system may include retracting a spindle drive when a closing signal of a tailgate is generated, stopping the spindle drive when a claw of a latch reaches a partially latched position as the tailgate is closed, and retracting the spindle drive while simultaneously performing latch cinching after the spindle drive is stopped. The latch cinching may be a process of moving the claw of the latch from the partially latched position to a fully latched position. By retracting the spindle drive while simultaneously performing the latch cinching, bending deformation in a portion of the tailgate to which the spindle drive is connected may be relatively reduced or prevented.

The method may further include stopping the latch and the spindle drive when the claw of the latch is in the fully latched position due to the latch cinching. After the claw of the latch has reached the fully latched position, a motor of the spindle drive may not operate so that vibration of the tailgate and noise of the motor may be prevented, and thus improved quality may be achieved.

When the closing signal is transmitted to a controller, the spindle drive may be retracted by applying a voltage corresponding to the closing signal to the motor of the spindle drive. As the voltage corresponding to the closing signal is applied to the motor of the spindle drive, a spindle of the spindle drive may rotate in a first rotation direction. Accordingly, as a movable tube moves to a retracted position, the tailgate may move to a closed position.

The closing signal of the tailgate may be generated by operating a tailgate switch in a state in which the tailgate is opened.

The spindle drive may include a drive tube, a movable tube moving relative to the drive tube, a motor provided to the drive tube, a spindle connected to the motor, and a spindle nut threaded with the spindle.

The movable tube may have a joint portion pivotally connected to the tailgate.

The spindle drive may further include a brake unit providing a brake torque to the spindle. The brake unit may include a first friction disk directly connected to the spindle, a second friction disk mounted in the drive tube, and a spring providing a spring force along a longitudinal axis of the drive tube to maintain contact between the first friction disk and the second friction disk.

The first friction disk and the second friction disk may be made of different materials. Accordingly, a relatively high friction force may be generated between the first friction disk and the second friction disk. For example, the first friction disk may be made of a synthetic resin material such as plastic, and the second friction disk may be made of a metal material such as steel.

The spindle drive may further include a gearbox configured to increase a torque generated by the motor and transmit the increased torque to the spindle. The gearbox may be located between the motor and the spindle. For example, the gearbox may include a planetary gear set.

The spindle drive may further include a spring configured to assist in opening the tailgate, and the spring may extend along a longitudinal direction of the movable tube.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 illustrates a power tailgate system according to an exemplary embodiment of the present disclosure;

FIG. 2 illustrates a latch and a striker of a power tailgate system according to an exemplary embodiment of the present disclosure, in a state in which a claw of the latch is in a partially latched position;

FIG. 3 illustrates a latch and a striker of a power tailgate system according to an exemplary embodiment of the present disclosure, in a state in which a claw of the latch is in a fully latched position;

FIG. 4 illustrates a cross-sectional view of a spindle drive of a power tailgate system according to an exemplary embodiment of the present disclosure;

FIG. 5 illustrates a perspective view of a tailgate of a power tailgate system according to an exemplary embodiment of the present disclosure;

FIG. 6 illustrates a system of measuring deformation of a tailgate of a power tailgate system; and

FIG. 7 illustrates a flowchart of a method for controlling a power tailgate system according to an exemplary embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with embodiments of the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

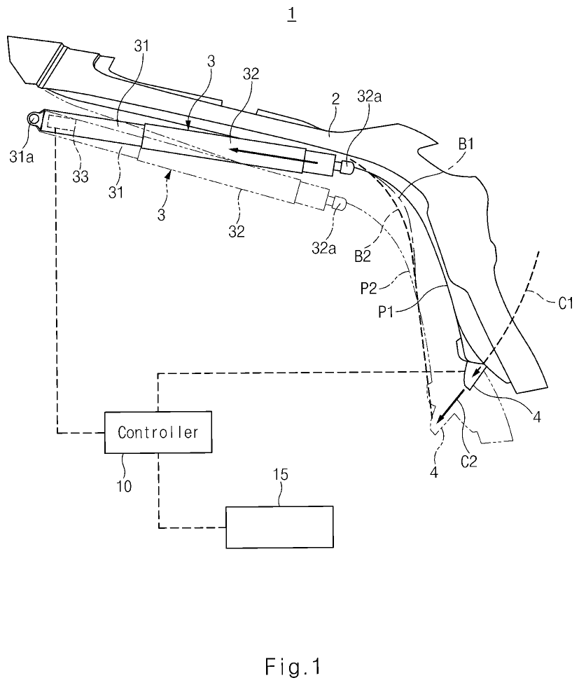

Referring to FIG. 1, a power tailgate system 1 according to an exemplary embodiment of the present disclosure may include a tailgate 2 opening and closing a luggage compartment provided on a rear portion of a vehicle body, and a spindle drive 3 causing the tailgate 2 to move between a closed position and an open position.

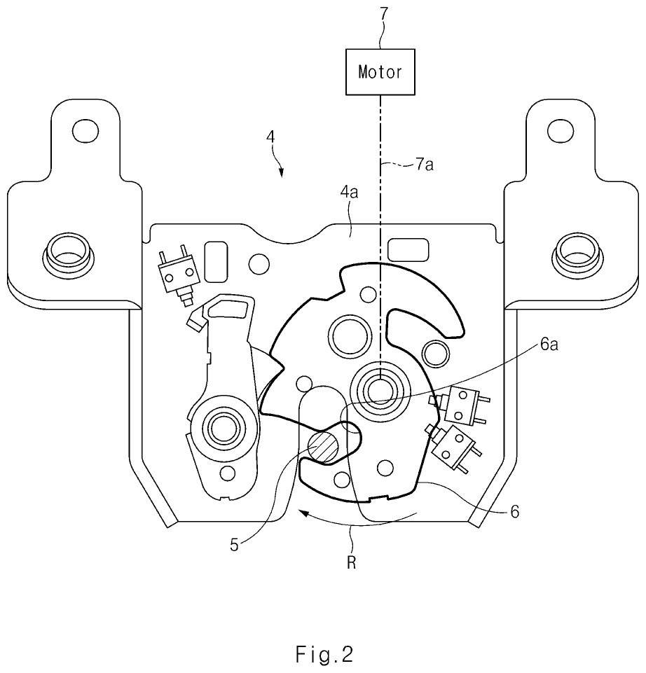

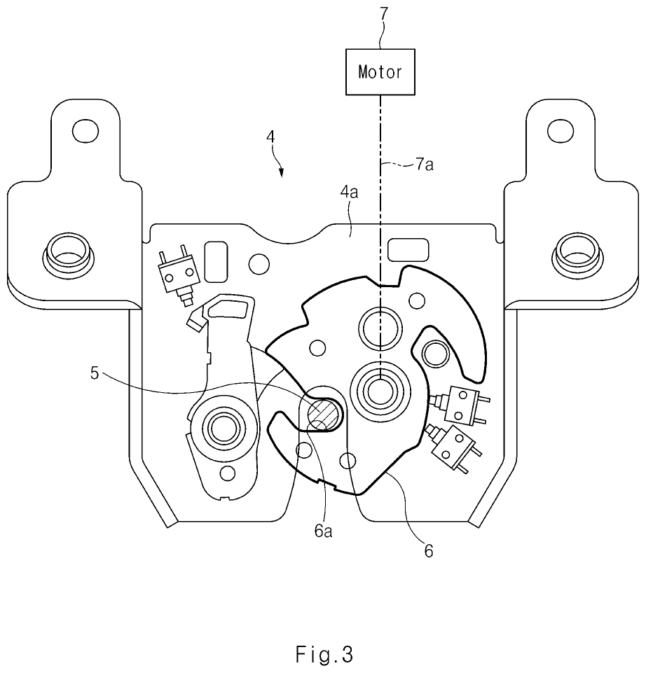

The tailgate 2 may be configured to move to a closed position and an open position by retraction or compression and extension of the spindle drive 3. The tailgate 2 may be held in the closed position by a latch system including a latch 4 and a striker 5. The latch 4 may be provided on a bottom end of the tailgate 2, and the striker 5 may be provided on the vehicle body. Referring to FIGS. 2 and 3, the latch 4 may include a claw 6 engaged with the striker 5, and a motor 7 driving the claw 6. The claw 6 may have a slot 6a in which the striker 5 is received, and the motor 7 may be connected to the claw 6 through a mechanical connection mechanism 7a. As the claw 6 is rotated by the motor 7 in a state in which the striker 5 is received in the slot 6a, the claw 6 may be partially or fully engaged with the striker 5.

When the tailgate 2 moves from the open position to the closed position by the retraction or compression of the spindle drive 3 (that is, the tailgate 2 is closed), the tailgate 2 may fail to move to a fully closed position due to a weather seal pressure between the vehicle body and the tailgate 2, but may move to a partially closed position. Accordingly, when the tailgate 2 is closed, latch cinching may be performed to assist the retraction or compression of the spindle drive 3 against the weather seal pressure. The latch cinching may be a process of moving (rotating) the claw 6 from a partially latched position or secondary latched position to a fully latched position or primary latched position by the motor 7.

When the tailgate 2 is in the partially closed position, the striker 5 may be partially received in the slot 6a of the claw 6 as illustrated in FIG. 2 so that the claw 6 may be in the partially latched position in which the claw 6 is partially engaged with the striker 5. When the tailgate 2 is in the fully closed position, the striker 5 may be fully received in the slot 6a of the claw 6 as illustrated in FIG. 3 so that the claw 6 may be in the fully latched position in which the claw 6 is fully engaged with the striker 5.

As a voltage corresponding to latch cinching is applied to the motor 7, the motor 7 may rotate the claw 6 in a predetermined direction (direction indicated by arrow R of FIG. 2) so that the claw 6 of the latch 4 may move (rotate) from the partially latched position (see FIG. 2) to the fully latched position (see FIG. 3). Accordingly, the claw 6 of the latch 4 may pull the striker 5 provided on the vehicle body so that the tailgate 2 may move from a partially closed position P1 to a fully closed position P2 against the weather seal pressure as indicated by arrow C2 of FIG. 1.

The spindle drive 3 may be retracted or compressed and be extended between the vehicle body and the tailgate 2. When the spindle drive 3 is retracted or compressed, the tailgate 2 may move from the open position to the closed position. When the spindle drive 3 is extended, the tailgate 2 may move from the closed position to the open position.

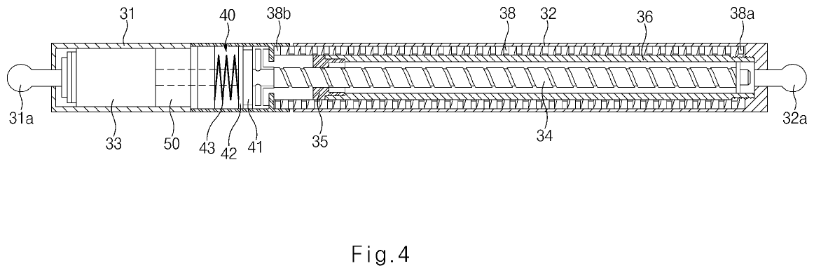

Referring to FIG. 4, the spindle drive 3 may include a drive tube 31 connected to the vehicle body, a movable tube 32 moving relative to the drive tube 31, a motor 33 provided to the drive tube 31, a spindle 34 connected to the motor 33, and a spindle nut 35 threaded with the spindle 34.

The drive tube 31 may have a joint portion 31a pivotally connected to the vehicle body. According to an exemplary embodiment, the joint portion 31a of the drive tube 31 may be a ball joint.

The movable tube 32 may have a joint portion 32a pivotally connected to the tailgate 2. According to an exemplary embodiment, the joint portion 32a of the movable tube 32 may be a ball joint.

The motor 33 may be fixedly mounted on the drive tube 31, and the motor 33 may be a bidirectional motor selectively rotatable in any one of a first rotation direction and a second rotation direction opposite to the first rotation direction.

The spindle 34 may be directly or indirectly connected to a rotor (not shown) of the motor 33, and the motor 33 may rotate the spindle 34 in any one of the first rotation direction and the second rotation direction. That is, the spindle 34 may be rotated by the motor 33 in any one of the first rotation direction and the second rotation direction.

The spindle 34 may be a threaded spindle having external threads on an outer circumferential surface thereof, and the spindle nut 35 may be a nut having internal threads on an inner circumferential surface thereof. The internal threads of the spindle nut 35 may mesh with the external threads of the spindle 34 so that the spindle nut 35 may be threaded with the spindle 34.

A spindle tube 36 may be disposed inside the movable tube 32. The spindle nut 35 may be fixed to the spindle tube 36, and the spindle tube 36 may be fixed to the movable tube 32. Accordingly, the spindle nut 35 may be connected to the movable tube 32 through the spindle tube 36.

As the spindle 34 is rotated by the motor 33, the spindle nut 35 may move on the spindle 34 along a longitudinal axis of the spindle 34. In particular, the spindle nut 35, the spindle tube 36, and the movable tube 32 may be connected to each other so that the spindle tube 36 and the movable tube 32 may move together with the spindle nut 35 in the same direction. Accordingly, the movable tube 32 may move between an extended position and a retracted position. The extended position refers to a position in which the movable tube 32 is relatively far away from the drive tube 31, and the retracted position refers to a position in which the movable tube 32 is close to the drive tube 31. When the movable tube 32 moves to the extended position, the spindle drive 3 may be extended, and accordingly the tailgate 2 may move to the open position. When the movable tube 32 moves to the retracted position, the spindle drive 3 may be retracted, and accordingly the tailgate 2 may move to the closed position.

Specifically, the motor 33 may have a first electrode and a second electrode. As the polarity of a voltage applied to the motor 33 changes, the direction of a current may change, and accordingly the rotation direction of the motor 33 may change. When a tailgate closing signal is transmitted to a controller 10, the controller 10 may apply a forward voltage to the first electrode of the motor 33 in response to the closing signal, and accordingly a current may flow in a first direction. As the rotor (not shown) of the motor 33 rotates in the first rotation direction, the spindle 34 may rotate in the first rotation direction. As the spindle 34 rotates in the first rotation direction, the spindle nut 35, the spindle tube 36, and the movable tube 32 may move to the retracted position. As the movable tube 32 moves to the retracted position, the spindle drive 3 may be retracted, and accordingly the tailgate 2 may move to the closed position. When a tailgate opening signal is transmitted to the controller 10, the controller 10 may apply a forward voltage to the second electrode of the motor 33 in response to the opening signal, and accordingly a current may flow in a second direction opposite to the first direction. As the rotor of the motor 33 rotates in the second rotation direction opposite to the first rotation direction, the spindle nut 35, the spindle tube 36, and the movable tube 32 may move to the extended position. As the movable tube 32 moves to the extended position, the spindle drive 3 may be extended, and accordingly the tailgate 2 may move to the open position.

According to an exemplary embodiment, the spindle drive 3 may further include a brake unit 40 providing a brake torque to the spindle 34. The brake unit 40 may include a first friction disk 41 directly connected to the spindle 34, a second friction disk 42 mounted in the drive tube 31, and a spring 43 providing a spring force along a longitudinal axis of the drive tube 31 to maintain contact between the first friction disk 41 and the second friction disk 42.

The first friction disk 41 may be connected to the spindle 34 to rotate together with the spindle 34 in the same direction. The second friction disk 42 may be blocked from moving in the rotation direction in the drive tube 31, and be allowed to move along the longitudinal axis of the drive tube 31. The spring 43 may push the second friction disk 42 toward the first friction disk 41 to maintain contact between the first friction disk 41 and the second friction disk 42, and a friction force may be generated between the first friction disk 41 and the second friction disk 42. When the spindle 34 is rotated by the motor 33, the first friction disk 41 and the second friction disk 42 may continuously contact so that the friction force and the brake torque may be continuously generated.

According to an exemplary embodiment, the first friction disk 41 and the second friction disk 42 may be made of different materials, and a relatively high friction force may be generated between the first friction disk 41 and the second friction disk 42. For example, the first friction disk 41 may be made of a synthetic resin material such as plastic, and the second friction disk 42 may be made of a metal material such as steel.

In case the tailgate 2 is stopped while moving, the brake unit 40 may provide the brake torque to the spindle 34 so that the tailgate 2 may be stably held in the stopped position, and sagging of the tailgate 2 may be prevented.

Referring to FIG. 4, the spindle drive 3 may further include a gearbox 50 configured to increase a torque generated by the motor 33 and transmit the increased torque to the spindle 34. The gearbox 50 may be located between the motor 33 and the spindle 34. According to an exemplary embodiment, the gearbox 50 may include a planetary gear set.

Referring to FIG. 4, the spindle drive 3 may further include a spring 38 configured to assist in opening the tailgate 2, and the spring 38 may extend along a longitudinal direction of the movable tube 32. The spring 38 may be disposed around the spindle tube 36, and the spring 38 may have a first end portion 38a and a second end portion 38b opposing each other. The first end portion 38a may be supported to the drive tube 31, and the second end portion 38b may be supported to the movable tube 32. Accordingly, when the tailgate 2 is opened, the spring 38 may provide a spring force allowing the movable tube 32 to be biased to the extended position.

Referring to FIG. 1, the spindle drive 3, the latch 4, and a tailgate switch 15 may be connected to the controller 10 through wiring or the like. In particular, the controller 10 may control the operation of the motor 33 of the spindle drive 3 and the operation of the motor 7 of the latch 4. As a user operates the tailgate switch 15, the controller 10 may generate the closing signal or the opening signal of the tailgate 2.

As the user operates the tailgate 2 in a state in which the tailgate 2 is opened, the controller 10 may generate the closing signal of the tailgate 2. When the closing signal of the tailgate 2 is generated, the controller 10 may control the motor 33 of the spindle drive 3 to cause the spindle drive 3 to be retracted. As the spindle drive 3 is retracted, the tailgate 2 may be closed (see direction indicated by arrow C1 of FIG. 1). While the tailgate 2 is being closed, it may be detected by various detectors or sensors that the claw 6 of the latch 4 has reached the partially latched position.

Meanwhile, in a method for controlling a power tailgate system according to the related art, when it is determined that the claw 6 of the latch 4 has reached the partially latched position, the controller 10 may stop the motor 33 of the spindle drive 3 so that the spindle drive 3 may be stopped. In a state in which the spindle drive 3 is stopped, the controller 10 may apply a predetermined voltage (electric energy) corresponding to latch cinching to the motor 7 of the latch 4 so that the latch cinching may be performed. That is, when the claw 6 moves from the partially latched position to the fully latched position due to the latch cinching, the claw 6 of the latch 4 may pull the striker 5. Since the spindle drive 3 is in the stopped state, a bending deformation amount B1 may be relatively high in a portion of the tailgate 2 connected to the joint portion 32a of the movable tube 32 of the spindle drive 3.

Here, since the spindle drive 3 is in the stopped state, a reaction force due to the friction force (the brake torque) generated from the brake unit 40 of the spindle drive 3 may act on the spindle drive 3 so that the bending deformation amount B1 of the tailgate 2 may be relatively high. In particular, while the claw 6 is moving from the partially latched position to the fully latched position, a retraction force of the spindle drive 3 may gradually increase, and accordingly the friction force generated from the brake unit 40 of the spindle drive 3 may increase to a maximum static friction force. Then, when the friction force generated from the brake unit 40 exceeds the maximum static friction force, the friction force may be reduced by a kinetic friction force.

Accordingly, the spindle drive 3 may be retracted or compressed to a predetermined displacement by the closing force of the tailgate 2. When the claw 6 reaches the fully latched position, the controller 10 may detect that the claw 6 has reached the fully latched position, and stop the motor 7 of the latch 4. The controller 10 may apply a predetermined voltage to the motor 33 of the spindle drive 3, and the spindle drive 3 may be retracted or compressed to a predetermined displacement. Here, as the spindle drive 3 is retracted, the bending deformation amount B1 of the tailgate 2 may be partially restored. However, as the motor 33 of the spindle drive 3 is driving even after the claw 6 is in the fully latched position, vibration of the tailgate 2 and noise of the motor 33 may be generated, resulting in reduced quality.

In the method for controlling a power tailgate system according to the related art, since the spindle drive 3 is in the stopped state when the claw 6 of the latch 4 performs latch cinching, stress concentration may excessively occur in the joint portion 32a of the spindle drive 3, and accordingly the tailgate 2 may be severely deformed. According to the related art, in order to minimize the deformation of the tailgate 2 when the tailgate 2 is closed, the thicknesses of reinforcements attached to the tailgate 2 may increase or the structures of the reinforcements may change, which may result in increased manufacturing cost and increased weight.

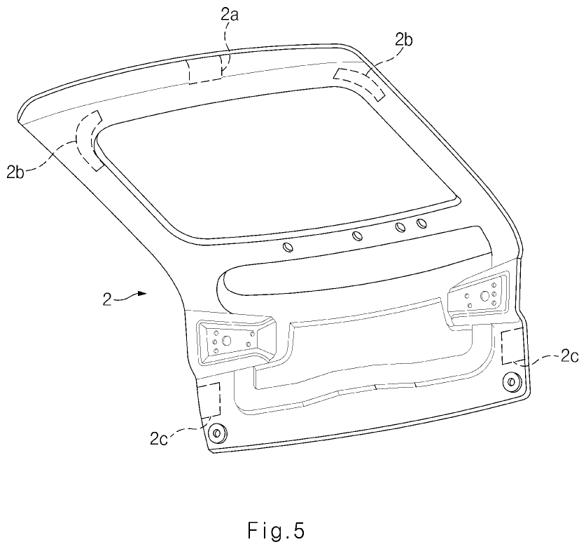

The tailgate 2 may have a plurality of reinforcements for various purposes such as reinforcement of hinge mounting, reinforcement of corner portions, and reinforcement of guide bumpers. Referring to FIG. 5, a hinge reinforcement 2a may be attached to an upper end portion of the tailgate 2, and a pair of quarter reinforcements 2b may be attached to upper corners of the tailgate 2, respectively. A pair of guide bumper reinforcements 2c may be attached to lower edges of the tailgate 2, respectively.

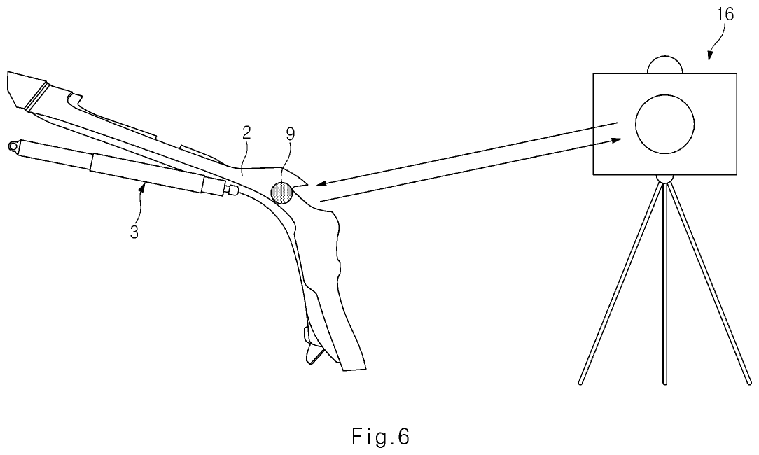

When the tailgate 2 is closed, a system for measuring the amount of deformation of the tailgate 2 will be described below. As illustrated in FIG. 6, a measurement point 9 may be marked on a portion of the tailgate 2. The measurement point 9 may be a point adjacent to the spindle drive 3 or a point adjacent to a rear lamp attached to the tailgate 2. The system may include closing the tailgate 2 in a state in which the spindle drive 3 is mounted, measuring a distance between a three-dimensional measuring camera 16 and the measurement point 9, and converting the measured distance into three-dimensional coordinates. Then, the system may include opening the tailgate 2, closing the tailgate 2 in a state in which the spindle drive 3 is detached, measuring a distance between the three-dimensional measuring camera 16 and the measurement point 9, and converting the measured distance into three-dimensional coordinates. By comparing the calculated three-dimensional coordinates before and after the spindle drive 3 is mounted, the amount of deformation of the tailgate 2 may be measured.

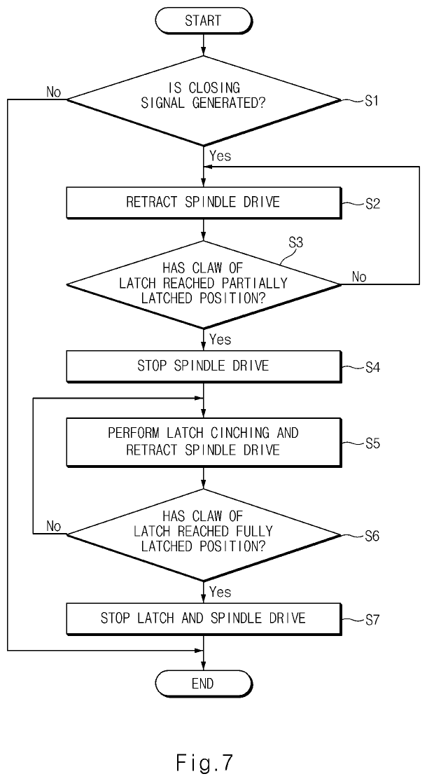

FIG. 7 illustrates a flowchart of a method for controlling a power tailgate system according to an exemplary embodiment of the present disclosure.

Referring to FIG. 7, the controller 10 may determine whether a closing signal of the tailgate 2 is generated (S1). As a user pushes the tailgate switch 15 in a state in which the tailgate 2 is opened, the closing signal of the tailgate 2 may be generated, and the closing signal of the tailgate 2 may be transmitted to the controller 10.

When the closing signal of the tailgate 2 is transmitted to the controller 10, the controller 10 may apply electric energy (voltage) corresponding to the closing signal of the tailgate 2 to the motor 33 of the spindle drive 3 so that the spindle drive 3 may be retracted or compressed (S2).

As the spindle drive 3 is retracted or compressed, the tailgate 2 may be closed (see direction indicated by arrow C1 of FIG. 1). While the tailgate 2 is being closed, it may be determined whether the claw 6 of the latch 4 has reached a partially latched position (see FIG. 2) in which the claw 6 of the latch 4 is partially engaged with the striker 5 (S3).

When it is detected by a detector or a sensor mounted in a latch housing 4a that the claw 6 has reached the partially latched position, a detected signal may be transmitted to the controller 10, and the controller 10 may stop the motor 33 of the spindle drive 3 to thereby stop the spindle drive 3 (S4).

After the spindle drive 3 is stopped, the controller 10 may apply electric energy (voltage) corresponding to latch cinching to the motor 7 of the latch 4 so that the latch cinching may be performed (see direction indicated by arrow C2 of FIG. 1), and simultaneously apply electric energy (voltage) corresponding to the closing signal of the tailgate 2 to the motor 33 of the spindle drive 3 so that the spindle drive 3 may be retracted or compressed (S5). Here, bending deformation in a portion of the tailgate 2 connected to the joint portion 32a of the spindle drive 3 may be minimized or prevented. According to an exemplary embodiment of the present disclosure, as the latch cinching is performed simultaneously while the spindle drive 3 is retracted or compressed, stress concentration applied to the joint portion 32a of the movable tube 32 of the spindle drive 3 may be relatively relieved. A bending deformation amount B2 of the tailgate 2 according to the exemplary embodiment of the present disclosure may be relatively reduced, compared to the bending deformation amount B1 of the tailgate according to the related art.

As the claw 6 of the latch 4 performs the latch cinching, it may be determined whether the claw 6 of the latch 4 has reached a fully latched position (see FIG. 3) in which the claw 6 of the latch 4 is fully engaged with the striker 5 (S6).

When it is detected by the detector or the sensor mounted in the latch housing 4a that the claw 6 has reached the fully latched position, a detected signal may be transmitted to the controller 10, and the controller 10 may block the electric energy from being applied to the motor 33 of the spindle drive 3 and the motor 7 of the latch 4 to thereby stop the spindle drive 3 and the latch 4 (S7). After the claw 6 has reached the fully latched position, the motor 33 of the spindle drive 3 may not operate so that vibration of the tailgate 2 and noise of the motor 33 may be prevented, and thus improved quality may be achieved.

As set forth above, in the method for controlling a power tailgate system according to exemplary embodiments of the present disclosure, by retracting the spindle drive while simultaneously performing the latch cinching, the bending deformation in a portion of the tailgate to which the spindle drive is connected may be relatively reduced or prevented.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for controlling a power tailgate system that comprises a tailgate, a spindle drive, and a latch, the method comprising:
retracting the spindle drive in response to a closing signal of the tailgate;
stopping the spindle drive when a claw of the latch reaches a partially latched position as the tailgate is closed; and
retracting the spindle drive while simultaneously performing latch cinching after the spindle drive is stopped, wherein performing the latch cinching comprises moving the claw of the latch from the partially latched position to a fully latched position.

2. The method according to claim 1, further comprising stopping the latch and the spindle drive when the claw of the latch is in the fully latched position due to the latch cinching.

3. The method according to claim 1, wherein, when the closing signal is transmitted to a controller, the spindle drive is retracted by applying a voltage corresponding to the closing signal to a motor of the spindle drive.

4. The method according to claim 1, wherein the spindle drive comprises a drive tube, a movable tube moving relative to the drive tube, a motor provided to the drive tube, a spindle connected to the motor, and a spindle nut threaded with the spindle.

5. The method according to claim 4, wherein the spindle drive further comprises a brake unit providing a brake torque to the spindle.

6. The method according to claim 5, wherein the brake unit comprises a first friction disk directly connected to the spindle, a second friction disk mounted in the drive tube, and a spring providing a spring force along a longitudinal axis of the drive tube to maintain contact between the first friction disk and the second friction disk.

7. The method according to claim 6, wherein the first friction disk and the second friction disk comprise different materials.

8. The method according to claim 4, wherein the spindle drive further comprises a gearbox configured to increase a torque generated by the motor and transmit the increased torque to the spindle.

9. The method according to claim 4, wherein the spindle drive further comprises a spring for assisting in opening the tailgate, and wherein the spring extends along a longitudinal direction of the movable tube.

10. A method for controlling a power tailgate system, the method comprising:
determining whether a closing signal of a tailgate is generated;
in response to a determination that the closing signal of the tailgate is generated, applying electric energy corresponding to the closing signal of the tailgate to a motor of a spindle drive to retract the spindle drive;
closing the tailgate as the spindle drive is retracted;
while closing the tailgate, determining whether a claw of a latch has reached a partially latched position in which the claw of the latch is partially engaged with a striker;
in response to a determination that the claw has reached the partially latched position, stopping the motor of the spindle drive to stop the spindle drive; and
after stopping the spindle drive, applying electric energy corresponding to latch cinching to a motor of the latch so that the latch cinching may be performed and simultaneously applying electric energy corresponding to the closing signal of the tailgate to the motor of the spindle drive to retract the spindle drive.

11. The method according to claim 10, further comprising:
during performing of the latch cinching, determining whether the claw of the latch has reached a fully latched position in which the claw of the latch is fully engaged with the striker; and
in response to a determination that the claw has reached the fully latched position, blocking the electric energy from being applied to the motor of the spindle drive to stop the spindle drive and blocking the electric energy from being applied to the motor of the latch to stop the latch.

12. The method according to claim 10, wherein the spindle drive comprises a drive tube, a movable tube moving relative to the drive tube, a motor provided to the drive tube, a spindle connected to the motor, and a spindle nut threaded with the spindle.

13. The method according to claim 12, wherein the spindle drive further comprises a brake unit providing a brake torque to the spindle.

14. The method according to claim 13, wherein the brake unit comprises a first friction disk directly connected to the spindle, a second friction disk mounted in the drive tube, and a spring providing a spring force along a longitudinal axis of the drive tube to maintain contact between the first friction disk and the second friction disk.

15. The method according to claim 14, wherein the first friction disk and the second friction disk comprise different materials.

16. The method according to claim 12, wherein the spindle drive further comprises a gearbox configured to increase a torque generated by the motor and transmit the increased torque to the spindle.

17. The method according to claim 12, wherein the spindle drive further comprises a spring for assisting in opening the tailgate, and wherein the spring extends along a longitudinal direction of the movable tube.

18. A power tailgate system comprising:
a tailgate;
a spindle drive comprising a spindle motor;
a latch system comprising a latch provided on a bottom end of the tailgate and a striker provided on a vehicle body, wherein the latch comprises a claw configured to engage with the striker and a latch motor configured to drive the claw, and wherein the claw comprises a slot in which the striker is received; and
a controller, wherein the controller is configured to:
generate a closing signal of the tailgate;
in response to the closing signal, control the spindle motor of the spindle drive to cause the spindle drive to be retracted and to cause the tailgate to be closed;
stop the spindle drive when the claw of the latch reaches a partially latched position as the tailgate is closed; and
control the spindle motor of the spindle drive to cause the spindle drive to retract again and simultaneously apply electric energy corresponding to latch cinching to the latch motor of the latch to perform the latch cinching, wherein the latch cinching comprises moving the claw of the latch from the partially latched position to a fully latched position.

19. The power tailgate system according to claim 18, wherein the spindle drive comprises a drive tube, a movable tube moving relative to the drive tube, a motor provided to the drive tube, a spindle connected to the motor, a spindle nut threaded with the spindle, and a brake unit providing a brake torque to the spindle.

20. The power tailgate system according to claim 19, wherein the brake unit comprises a first friction disk directly connected to the spindle, a second friction disk mounted in the drive tube, and a spring providing a spring force along a longitudinal axis of the drive tube to maintain contact between the first friction disk and the second friction disk.
